(19) United States
(12) Patent Application Publication
(10) Pub. No.: US 2021/0225137 A1
(43) Pub. Date: Jul. 22, 2021

(54) SWAY MITIGATION FOR MATERIAL HANDLING

(71) Applicant: PAR SYSTEMS, INC., Shoreview, MN (US)

(72) Inventors: Khalid Sorensen, Mableton, MN (US); Adam Marsh, Forest Lake, MN (US); Miles Close, Lino Lakes, MN (US); Brandon Halonen, Blaine, MN (US)

(21) Appl. No.: 16/088,385

(22) PCT Filed: Aug. 15, 2018
(86) PCT No.: PCT/US2018/000136

§ 371 Date: Sep. 25, 2018

Related U.S. Application Data
(60) Provisional application No. 62/545,840, filed on Aug. 15, 2017.

(51) Int. Cl. G08B 6/00; B66C 13/06; B66C 13/40; G05B 19/05

(52) U.S. Cl. CPC G08B 6/00; B66C 13/063; G05B 2219/15053; G05B 19/05; B66C 13/40

(57) ABSTRACT

A vibration control system for a radio controlled device, including a radio controller and a radio receiver. The radio controller is configured to provide control commands to the radio receiver, including activation and deactivation of vibration control. One of the radio receiver or the radio controller includes a vibration control configured to provide vibration control commands to the radio controlled device.

### FIELD

Aspects of the present disclosure relate to pendant controlled systems, such as crane and/or hoist systems, and in particular to vibration control and/or mitigation of sway in pendant controlled systems such as crane and/or hoist systems.

### BACKGROUND

Currently, payload swing mitigation can be accomplished using a separate piece of equipment, or several pieces. These types of solutions can be expensive, cumbersome, and time-consuming to install. For example, some PLC-based anti-sway systems intercept radio commands and issue modified commands to motor drives as shown in FIG. 1. Anti-sway control technology is embedded in software installed on the stand-alone PLC. These systems are installed by cutting wires between the crane motor drives and a radio receiver that transmits operator commands to the drives, and installing the PLC therebetween. This requires physical rewiring, which can be expensive and prone to error.

### SUMMARY

This Summary and the Abstract herein are provided to introduce a selection of concepts in a simplified form that are further described below in the Detailed Description. This Summary and the Abstract are not intended to identify key features or essential features of the claimed subject matter, nor are they intended to be used as an aid in determining the scope of the claimed subject matter. The claimed subject matter is not limited to implementations that solve any or all disadvantages noted in the Background.

One general aspect includes a vibration control system for a radio controlled device, including a radio controller and a radio receiver. The radio controller is configured to provide control commands to the radio receiver, including activation and deactivation of vibration control. One of the radio receiver or the radio controller includes a vibration control configured to provide vibration control commands to the radio controlled device.

Implementations may include one or more of the following features. The vibration control system where the radio receiver further includes a user interface configured to accept vibration control parameters for the vibration control. The vibration control system where the radio controller further includes a user interface configured to accept vibration control parameters for the vibration control. The vibration control system where the radio controller and the radio receiver are coupled using wireless communication. The vibration control system where the radio receiver further includes an output configured to provide vibration control signals to the radio controlled device. The vibration control system where the radio controller includes a toggle switch for activation and deactivation of vibration control. The vibration control system where the radio controller is configured to control an electro-mechanical motor device. The vibration control system where the radio controller is configured to control a servo-controlled hydraulic device. The vibration control system where the vibration control is sway mitigation. The vibration control system where the radio controller is a belly box. The vibration control system where the radio controller is a pendant-type device.

One general aspect includes a vibration control system, including a pendant controlled device and a vibration control configured to control operation of the pendant controlled device. The vibration control system also includes a radio controller. The vibration control system also includes a radio receiver, the radio controller configured to provide vibration control commands to the radio receiver, including activation and deactivation of vibration control. The vibration control system also includes where the radio receiver includes a vibration control configured to provide vibration control commands to the pendant controlled device.

Implementations may include one or more of the following features. The vibration control system where the pendant controlled device is a crane. The vibration control system where the radio receiver further includes a user interface configured to accept vibration control parameters for the vibration control. The vibration control system where the radio controller further includes a user interface configured to accept vibration control parameters for the vibration control. The vibration control system where the radio controller is configured to control an electro-mechanical motor device. The vibration control system where the radio controller is configured to control a servo-controlled hydraulic device. The vibration control system where the vibration control is sway mitigation. The vibration control system where the radio controller is a belly box. The vibration control system where the radio controller is a pendant-type device.

One general aspect includes a method of retro-fitting a pendant controlled device with anti-vibration control, including providing a radio receiver that is configured for communication with a drive mechanism of a pendant controlled device, providing a radio controller configured to accept movement commands from an operator, and providing sway mitigation control in one of the radio controller or the radio receiver. The sway mitigation control is configured to provide output commands to the pendant controlled device.

### BRIEF DESCRIPTION OF DRAWINGS

FIG. 1 is a diagrammatic view of a typical PLC based anti-sway solution;

FIG. 2 is a diagrammatic view of a radio control-based anti-sway system according to an embodiment of the disclosure; and

FIG. 3 is a schematic view of a computer or controller on which embodiments of the present disclosure may be practiced.

### DETAILED DESCRIPTION

Embodiments of the present disclosure provide anti-sway control systems for industrial cranes including, for example only and not by way of limitation, heavy equipment production cranes, primary metals coil cranes, general purpose single and double girder bridge cranes, and the like.

The present disclosure relates to improvements in vibration and sway mitigation methods and operation, especially as it relates to anti-sway technology. The terms vibration control and sway mitigation relate to control of oscillatory movement of loads or structures resulting from movement or actuation of the loads or structures.

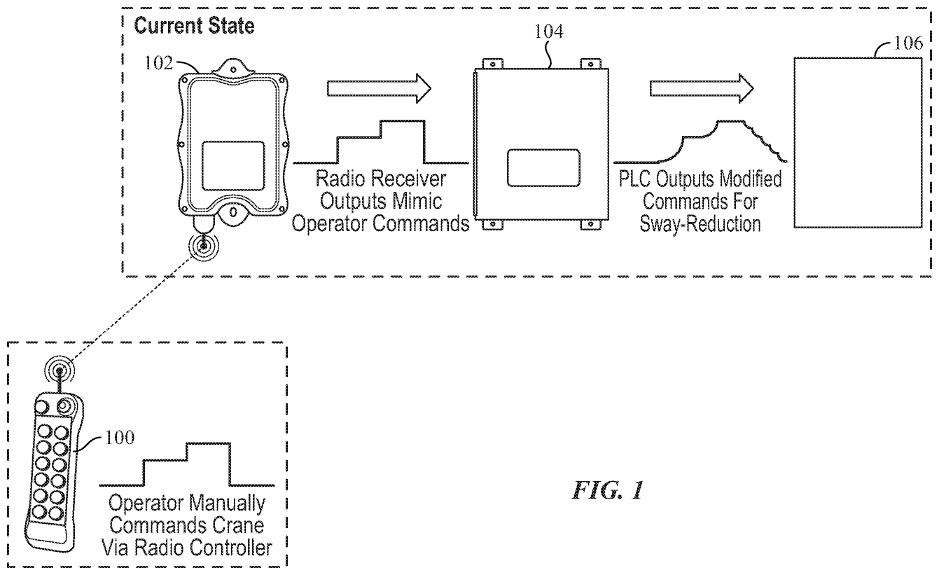

With respect to cranes in particular, software-based anti-sway technology is usually embedded into motor drives of a crane, or embedded into a microcontroller separate from the motor drives, such as in a programmable logic controller (PLC) that intercepts crane radio control signals, applies logic to implement anti-sway commands, and sends those commands to one or more motor drives that are used to actuate the crane motors. The latter implementation is shown in FIG. 1. A radio controller 100 is used by an operator to issue crane control commands. Those commands are sent, typically wirelessly, to a radio receiver 102, which communicates with the drives 106 of a pendant-operated device (e.g., a crane) through a PLC 104. Implementation of drive-based anti-sway involves the expensive and time-consuming task of physically replacing ordinary motor drives of a crane with anti-sway equipped motor drives. Implementation of PCE-based anti-sway requires cutting of wires between the radio receiver 102 and drives 106, and installation of a separate piece of equipment, i.e. the PLC 104.

Additional anti-sway solutions use a camera in combination with an algorithm on a computing device, such as a PLC or a microprocessor in a motor drive to issue swing-mitigating commands to the motor drives. Still other solutions use a sensor or plurality of sensors providing information to an anti-sway controller.

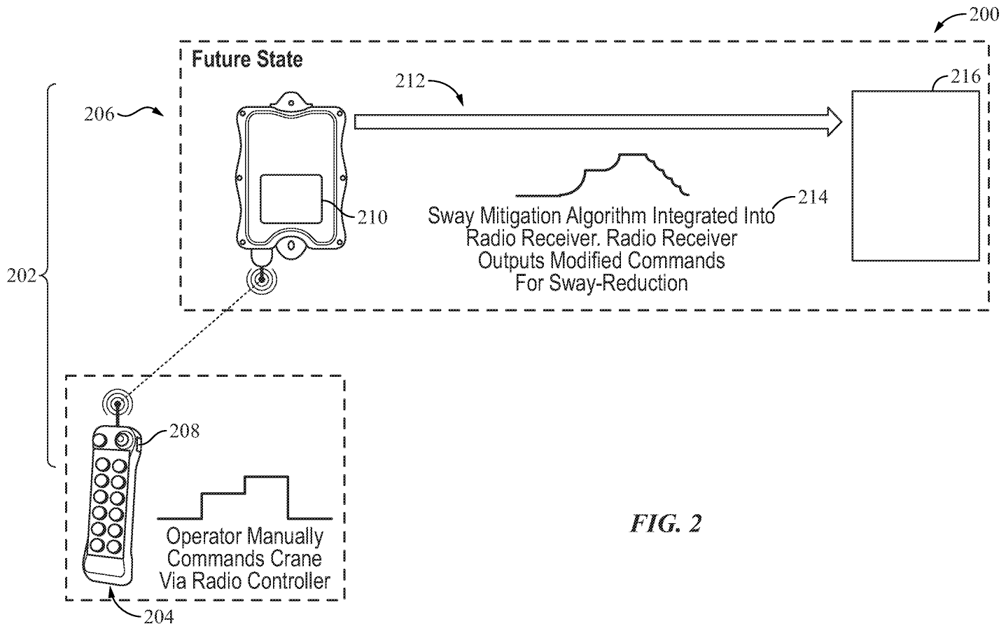

Embodiments of the present disclosure may be used for payload vibration or swing mitigation. Embodiments of the present disclosure, shown for example in FIG. 2, implement a radio receiver 206 with built-in logic for vibration control. An operator uses a radio controller (also referred to as a belly box or pendant) 204 to send signals to the radio receiver 206, and the embedded logic therein creates commands that are directly sent to the drives 216 of the pendant controlled device, and implements vibration and/or sway mitigation or control technology. Replacement of a conventional radio controller and radio receiver (i.e., those not equipped with anti-sway) with those disclosed as embodiments of the present disclosure is less costly and easier to implement than conventional vibration and/or sway mitigation technologies. Radio controllers 204 and radio receivers 206 are relatively inexpensive compared to new motor drives, and installation and maintenance of separate PLCs. Still further, vibration control technology that does not rely on sensors can be implemented into the radio controller 204 and radio receiver 206, since no signals need to be received from sensors by the radio receiver 206 or radio controller 204.

Therefore, instead of a separate enclosure that is mounted in series with a pendant controlled device, logic for operating the vibration control and/or sway mitigation is embedded into a radio controller 204 or a radio receiver 206 of a radio controller/radio receiver pair 202. Radio pendants are often and easily replaced, and are relatively inexpensive.

Embodiments of the present disclosure provide sway mitigation/vibration control solutions that are implemented on a radio controller/radio receiver pair 202. No sensors are used. Prior art anti-sway solutions using sensors cannot be placed onto the set 202 because the radio receiver portion 206 of the set 202 does not receive additional input from other sensors.

Radio receiver control of pendant controlled devices from a hand-held radio controller (e.g., a pendant or belly box) currently does not offer vibration control of this type at the immediate hands of an operator. While many pendant controlled devices have conventional anti-sway systems with an on/off switch on a pendant, there is no anti-sway or other vibration control located on the radio controller. Embodiments of the present disclosure provide a radio controller 204 with a toggle or other switch used to activate/deactivate vibration control. In one embodiment, the anti-sway control software/firmware that is used to create outputs suitable for providing anti-sway control is provided within the radio receiver 206 itself. In one embodiment, the radio receiver 206 is modified to include one or more of firmware that implements anti-sway control, or a user interface such as a human machine interface (HMI) for setting parameters of anti-sway control. An additional PLC or other controller is no longer used.

The present disclosure integrates anti-sway control into commercially available radio receivers that are used as standard devices on many cranes. Implementation of a solution with the anti-sway control on the radio receiver 206 (or radio controller 204) will be at lower cost, with large market exposure. Moreover, embodiments of the present disclosure are directed toward sensorless anti-sway for cranes, with retrofittable solutions on relatively inexpensive and easily replaced pendant-type controllers. For example, pendant controlled devices that are amenable to use with embodiments of the present disclosure include, by way of example only and not by way of limitation, gantry cranes, mobile or tower cranes, knuckle-boom cranes, material handling cranes, service cranes, boom pumps such as concrete pumping truck booms, fire and rescue truck booms, aerial lift trucks, bridge and railway inspection units, and the like.

Referring to FIG. 2, one embodiment 200 of the present disclosure provides a pendant 202 comprising radio controller 204 and radio receiver 206. The radio controller 204 is a standard off the shelf controller with a toggle switch 208 added so that the user can indicate whether anti-sway control of a crane should be on or off. In this embodiment, the radio receiver 206 is loaded with a sway mitigation and/or vibration control algorithm. The radio receiver 206 can also include a human machine interface (HMI) 210 to allow a user to set parameters directly at the radio receiver 206. The radio receiver 206 provides an output 212 (analog and/or discrete and/or digital) indicative of the desired crane speed that has been modified in view of an anti-sway control algorithm. Motor drives 216 of a crane or the like amenable to use with the embodiments of the present disclosure include any drive such as but not limited to DC drives and variable frequency drives (VFD) that accepts an analog speed reference. In one embodiment, motor drive parameters are configured to accurately track the speed reference commands issued from the radio receiver.

Sway mitigation technology as provided in the embodiments of the present disclosure improves site and crane safety, reduces collisions, reduces maintenance and training, increases productivity, provides sensorless sway reduction, and is retrofittable to existing cranes. Inclusion of the sway mitigation control into the receiver allows for retrofitting to drives that would otherwise not be amenable to anti-sway control without large expense, opening up a market of smaller and less expensive cranes to the benefit of anti-sway control, as well as other motor drive radio pendant operated devices such as those listed herein.

Advantages of embodiments of the present disclosure further include, by way of example only and not by way of limitation, lower down time on radio pendant controlled devices for install and replacement of anti-sway control, faster installation, lower cost, easily replaceable components (e.g., radio controller 204 and/or radio receiver 206) without significant downtime or modification of existing expensive components. Sway mitigation control embodiments of the present disclosure provide cost-effective anti-sway control for lower cost cranes (e.g., those cranes in the 5-20 ton range) and other radio pendant controlled devices such as those listed herein, since current anti-sway technology may in fact have a cost close to that of the crane or device itself.

Embodiments of the present disclosure are compatible with existing variable frequency drives for cranes and other devices. Enabling and disabling embodiments of the present disclosure may be accomplished with existing wired or radio pendants. Embodiments of the present disclosure are configured to be retrofitted onto existing hardware platforms, including but not limited to heavy equipment production cranes, primary metals coil cranes, and general purpose single & double girder bridge cranes. Embodiments of the present disclosure may be used in standalone form, or in conjunction with other crane control technology, for example only and not by way of limitation, with Cranevision™, Expertoperator™, Safemove™, and Automove™ offered by PaR Systems of Shoreview, Minn.

The anti-sway control firmware/software, such as that embedded in the radio receiver 206, is usable on all the hoist and other systems herein described. It can comprise in various embodiments a digital computer within the radio receiver 206. The logic to implement the control features may also be implemented with an appropriate input/output configuration coupled to a computer or computing environment.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. Other embodiments include corresponding computer systems, apparatus, and computer programs recorded on one or more computer storage devices, each configured to perform the actions of the methods.

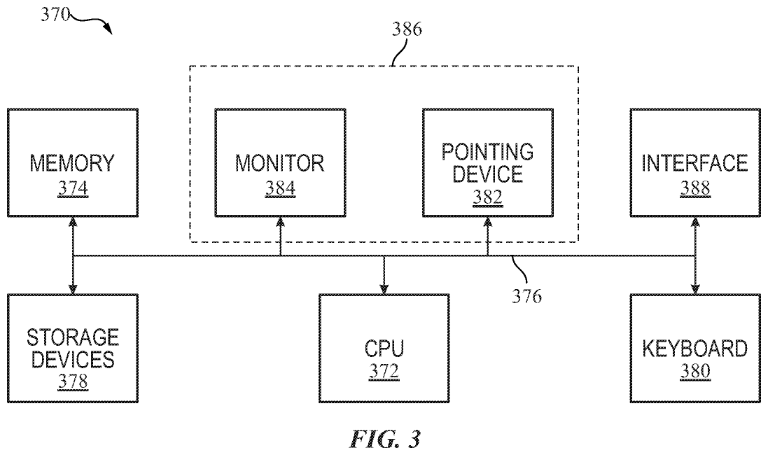

FIG. 3 and the related discussion provide a brief, general description of a suitable computing environment in which a system controller such as those used in the present disclosure can be implemented. For example, a computing environment such as that shown in FIG. 3 may be used to program and/or control the anti-sway operation of a system such as system 200. Although not required, the system controller can be implemented at least in part, in the general context of computer-executable instructions, such as program modules, being executed by a computer or microcontroller 370. Generally, program modules include routine programs, objects, components, data structures, etc., which perform particular tasks or implement particular abstract data types. Those skilled in the art can implement the description herein as computer-executable instructions storable on a computer readable medium. Moreover, those skilled in the art will appreciate that the invention may be practiced with other computer system configurations, including multi-processor systems, networked personal computers, mini computers, main frame computers, and the like. Aspects of the invention may also be practiced in distributed computing environments where tasks are performed by remote processing devices that are linked through a communications network. In a distributed computer environment, program modules may be located in both local and remote memory storage devices.

The computer/microcontroller 370 comprises a conventional computer having a central processing unit (CPU) 372, memory 374 and a system bus 376, which couples various system components, including memory 374 to the CPU 372. The system bus 376 may be any of several types of bus structures including a memory bus or a memory controller, a peripheral bus, and a local bus using any of a variety of bus architectures. The memory 374 includes read only memory (ROM) and random access memory (RAM). A basic input/output (BIOS) containing the basic routine that helps to transfer information between elements within the computer 370, such as during start-up, is stored in ROM. Storage devices 378, such as a hard disk, a floppy disk drive, an optical disk drive, etc., are coupled to the system bus 376 and are used for storage of programs and data. It should be appreciated by those skilled in the art that other types of computer readable media that are accessible by a computer, such as magnetic cassettes, flash memory cards, digital video disks, random access memories, read only memories, and the like, may also be used as storage devices. Commonly, programs are loaded into memory 374 from at least one of the storage devices 378 with or without accompanying data.

Input devices such as a keyboard 380 and/or pointing device (e.g. mouse, joystick(s)) 382, or the like, allow the user to provide commands to the computer 370. A monitor 384 or other type of output device can be further connected to the system bus 176 via a suitable interface and can provide feedback to the user. If the monitor 384 is a touch screen, the pointing device 382 can be incorporated therewith. The monitor 384 and input pointing device 382 such as mouse together with corresponding software drivers can form a graphical user interface (GUI) 386 for computer 370. Interfaces 388 on the system controller 300 allow communication to other computer systems if necessary. Interfaces 388 also represent circuitry used to send signals to or receive signals from the actuators and/or sensing devices mentioned above. Commonly, such circuitry comprises digital-to-analog (D/A) and analog-to-digital (A/D) converters as is well known in the art.

Such a computer/microcontroller 370 may be a part of the radio receiver 206, or radio controller 204, or a combination thereof, without departing from the scope of the disclosure.

Although the subject matter has been described in language directed to specific environments, structural features and/or methodological acts, it is to be understood that the subject matter defined in the appended claims is not limited to the environments, specific features or acts described above as has been held by the courts. Rather, the environments, specific features and acts described above are disclosed as example forms of implementing the claims.

1. A vibration control system for a radio controlled device, comprising:
a radio controller; and
a radio receiver, the radio controller configured to provide control commands to the radio receiver, including activation and deactivation of vibration control; and
wherein one of the radio receiver or the radio controller comprises a vibration control configured to provide vibration control commands to the radio controlled device.

2. The vibration control system of claim 1, wherein the radio receiver further comprises a user interface configured to accept vibration control parameters for the vibration control.

3. The vibration control system of claim 1, wherein the radio controller further comprises a user interface configured to accept vibration control parameters for the vibration control.

4. The vibration control system of claim 1, wherein the radio controller and the radio receiver are coupled using wireless communication.

5. The vibration control system of claim 1, wherein the radio receiver further comprises an output configured to provide vibration control signals to the radio controlled device.

6. The vibration control system of claim 1, wherein the radio controller comprises a toggle switch for activation and deactivation of vibration control.

7. The vibration control system of claim 1, wherein the radio receiver is configured to control an electro-mechanical motor device.

8. The vibration control system of claim 1, wherein the radio receiver is configured to control a servo-controlled hydraulic device.

9. The vibration control system of claim 1, wherein the vibration control is sway mitigation.

10. The vibration control system of claim 1, wherein the radio controller is a belly box.

11. The vibration control system of claim 1, wherein the radio controller is a pendant-type device.

12. The vibration control system of claim 1, wherein the vibration control system is sensorless.

13. A vibration control system, comprising:
a pendant controlled device;
a vibration control configured to control operation of the pendant controlled device, the vibration control comprising:
a radio controller; and
a radio receiver, the radio controller configured to provide user vibration control commands to the radio receiver, including activation and deactivation of vibration control; and
wherein the radio receiver comprises a vibration control module configured to provide modified vibration control commands to the pendant controlled device.

14. The vibration control system of claim 13, wherein the pendant controlled device is a crane.

15. The vibration control system of claim 13, wherein the radio receiver further comprises a user interface configured to accept vibration control parameters for the vibration control.

16. The vibration control system of claim 13, wherein the radio controller further comprises a user interface configured to accept vibration control parameters for the vibration control.

17. The vibration control system of claim 13, wherein the radio receiver is configured to control an electro-mechanical motor device.

18. The vibration control system of claim 13, wherein the radio receiver is configured to control a servo-controlled hydraulic device.

19. The vibration control system of claim 13, wherein the vibration control is sway mitigation.

20. The vibration control system of claim 13, wherein the radio controller is a belly box.

21. The vibration control system of claim 13, wherein the radio controller is a pendant-type device.

22. A method of retro-fitting a pendant controlled device with anti-vibration control, comprising:
providing a radio receiver that is configured for communication with a drive mechanism of a pendant controlled device;
providing a radio controller configured to accept movement commands from an operator; and
providing sway mitigation control in one of the radio controller or the radio receiver, the sway mitigation control configured to provide output commands to the pendant controlled device.

23. The vibration control system of claim 1, wherein the radio controller is a remote processing device.
